(19) United States
(12) Patent Application Publication
(10) Pub. No.: US 2017/0341084 A1
(43) Pub. Date: Nov. 30, 2017

(54) RECYCLING PLANT FOR GYPSUM PLASTERBOARD

(71) Applicant: Neuenhauser Maschinenbau GmbH, Neuenhaus (DE)

(72) Inventors: Wolfgang BROUWER, Uelsen (DE); Martin EVES, County Donegal (IE)

(21) Appl. No.: 15/520,974

(22) PCT Filed: Oct. 21, 2015
(86) PCT No.: PCT/DE2015/100440

§ 371 Date: Apr. 21, 2017

(30) Foreign Application Priority Data
Oct. 22, 2014 (DE) 10 2014 115 409.6

(51) Int. Cl. B02C 23/14; B02C 4/32; B02C 4/30; B03B 9/06; B02C 4/08

(52) U.S. Cl. CPC B02C 23/14; B03B 9/065; B02C 4/08; B02C 4/30; B02C 4/32

(57) ABSTRACT

A recycling plant for gypsum plasterboard is disclosed having three roller crushers and three screens. The rollers can operate at varying rotational speeds and, as a result of the different rotational speeds of the rollers, the plasterboard pieces are comminuted such that the plaster of the paper or the carton is detached.

### CROSS REFERENCE TO RELATED APPLICATIONS

The present application is a National Phase of International Application Number PCT/DE2015/100440 filed Oct. 21, 2015 and related to and claims priority benefits from German Patent Application Number 10 2014 115 409.6 filed Oct. 22, 2014.

### BACKGROUND OF THE INVENTION

### 1. Field of the Invention

The present invention relates to a recycling plant, and more specifically, to a recycling plant for gypsum plasterboard.

### 2. Description of the Related Art

Gypsum-plasterboard panels are known from the prior art for various applications in the construction industry, in particular for interior work. Gypsum plasterboard panels are usually designed such that an underside and an upper side consist of a paper or of a paperboard and a gypsum material is arranged therebetween. The gypsum boards are also known as gypsum-plasterboard panels. They are available for example in different sizes for different use purposes, also for dry rooms and wet rooms. The gypsum-plasterboard panels are usually a number of square meters in size.

The gypsum-plasterboard panels are used here for interior work and/or dry construction or else dry plaster, and the panels are fastened on a batten arrangement or a substructure. This fastening is usually done by screws. Alternatively or additionally, the gypsum-plasterboard panels may be adhesively bonded to the batten arrangement or to one another. The batten arrangement or substructure is formed either from wood, in particular roof battens and/or profile rails. The profile rails themselves are formed, in particular, from a metallic steel material.

In the case of demolition or dismantling work, the wall cladding or walls produced from gypsum boards are thus demolished and are in differently sized pieces. This demolition material therefore has components of the gypsum-plasterboard panels, but also of wood, metal and other stones or fittings as well as screws and nails, and occasionally also parts of a sanitary installation or electrical installation.

In order for the gypsum-plasterboard to be recycled, it is necessary for the various extraneous materials such as wood, metal or other extraneous materials to be separated off and the gypsum-plasterboard to be separated into its constituent parts: gypsum and paperboard or paper. Gypsum board, however, has the special feature that the gypsum is coupled, in particular integrally, to the paperboard. For example, EP 2 473 294 B1 discloses a recycling plant for gypsum-plasterboard having comminuting apparatuses, separators and screens. WO 2012/020607 A1, JP 2012 024690 A, EP 1 421 995 A1 and JP 2004 243165 A also disclose recycling plants for gypsum boards.

### SUMMARY OF THE INVENTION

It is an object of the present invention to provide a facility for recycling gypsum-plasterboard panels, in particular stemming from dismantling work or demolition material, and which is of straightforward and efficient construction and can be adapted to different demolition-material compositions.

The recycling plant for gypsum-plasterboard comprises a receiving apparatus for receiving comminuted gypsum boards in pieces measuring from 0 to 1000 mm, and more specifically, from 300 to 500 mm, and further includes a first magnetic separator for separating off large metallic contaminants, a first shredder for comminuting the gypsum boards into pieces measuring from 10 to 100 mm, and more specifically from 60 to 80 mm. The recycling plant also includes a second magnetic separator for separating off metallic components, a first screen for screening off gypsum particles smaller than 3 mm, and particularly smaller than 1.8 mm, a second shredder for comminuting the pieces of gypsum board from the first screening installation, a second screen for screening off paper and undesirable materials, a third shredder for comminuting the pieces of gypsum, and a third screen for screening off the gypsum particles smaller than 3 mm, and preferably smaller than 1.8 mm.

Conveyors are used between the individual components. The conveyors are usually in the form of conveying belts. However, it is also possible to use vibration conveyors, worm or screw conveyors or other types of known conveyor in order to convey the respective materials from one component of the recycling plant to the next component and/or from one component to a collecting device, for example a container.

The recycling plant further includes a receiving apparatus, in particular a bunker, in which the previously comminuted parts of the gypsum boards which are to be recycled or demolished are introduced. These are in pieces measuring between 0 and 1000 mm, and more specifically between 300 and 500 mm. The corresponding pieces of gypsum board, but also other contaminants or other mixed construction waste, for example parts of a counter-batten arrangement, screws, residues of applied plaster or other contaminants or also secondary products are also contained herein.

The material is fed by the receiving apparatus to a first conveying belt, which is provided with a magnetic separator for separating off large metallic contaminants. The loose parts of profile pieces and in particular screw connections of the gypsum boards are separated off here by the magnetic separator. The magnetic separator here may be of any desired design variant. It attracts the metallic workpieces in particular using a magnetic force, and said workpieces are therefore withdrawn from the material in a first stage.

The material cleaned of coarse metallic contaminants is then conveyed to a first shredder via a conveying device. In the first shredder the material is comminuted into pieces measuring from 10 to 100 mm, in particular from 60 to 80 mm. The first shredder here is designed, in particular, in the form of a screw mill, quite particularly preferably with three pairs of rollers.

The two upper pairs of rollers here operate at the same rotational speed of 20 to 40 rpm, preferably 25 to 35 rpm, and more specifically 30 rpm. The third pair of rollers, which differs from the latter pairs of rollers, has a higher rotational speed of 100 to 150 rpm, preferably 120 to 140 rpm, and more specifically of 130 rpm.

The two upper pairs of rollers are configured as screw rollers and pre-comminute the material. The lower pair of rollers has particularly preferably 2 to 10, in particular 5 or 6, cutting bars. These cutting bars mesh in particular with a blade. The material is thus pre-comminuted by the upper screw rollers, wherein the third pair of rollers then comminutes the pre-comminuted material into the preferred size of pieces measuring from 60 to 80 mm. Gentle comminution is the result, in particular, of the pairs of rollers operating slowly, in which case paperboard or paper fibers are separated off as little as possible from the gypsum, and therefore the paper fibers are not introduced individually into the material. At the same time, the slow operation gives rise to a low power input for, and accordingly low power consumption of, the first shredder.

Moreover, the distance between the two rollers of the lowermost pair of rollers may be adjusted by an actuator such as, but not limited to, a hydraulic cylinder. A corresponding undesirable material can be detected here via a sensor, and the undesirable material can be avoided by virtue of the distance between the rollers being increased. For example, it is possible for solid pieces of metal or else also stones or the like, which have a considerably higher moment of resistance to comminution, to be detected in this way and for the abrasive wear to the pairs of rollers to be reduced as a result. The service life of the plant according to the invention, in particular of the first shredder is thus increased.

A changeover of the rollers of the third pair of rollers and/or an increase in the distance between the third pair of rollers can directly influence the size of the pieces of material fed to the further components.

The first shredder is followed by a second magnetic separator, which separates off, or screens or filters out, in particular the now metallically detached components still located in the material for continued recycling. In particular screw connections, which secured the gypsum boards to a batten arrangement or a profile and are of some significant size following the first shredder, can be separated out.

The second magnetic separator is followed by a first screen for screening off the gypsum particles. The gypsum particles which are screened off are in particular smaller than 3 mm, preferably smaller than 2 mm, quite preferably smaller than 1.8 mm. On account of the first shredder, parts of the gypsum are comminuted such that particles break off or crumble. These small gypsum particles can thus be screened out in the first screen, which is designed in particular in the form of a flip-flow screen. However, it is also possible; to use any other screening installation for screening out particles. The screened-out gypsum particles are then fed, preferably from the first screen, into a receiving apparatus for receiving the gypsum particles, and are collected therein, it therefore being possible for the gypsum particles to be fed on for further use, in particular further recycling.

The rest of the material from which the gypsum particles have been screened out is then fed via a conveying apparatus, in particular a conveying belt, to a second shredder for comminuting the pieces of gypsum plasterboard further. In particular, the second shredder is a roller crusher, which has a pair of rollers, in other words two rollers. The two rollers particularly preferably have different profiles, wherein in particular one profile is designed in the form of a chevron profile and the other roller has an annular profile.

Preferably, each roller may include a dedicated drive motor, wherein it is likewise particularly preferable for the distance between the two rollers to be adjustable via an actuator. Therefore, each dedicated drive motor allows the two rollers to operate at different rotational speeds from one another. This results in good separation of paperboard or paper and gypsum. The paperboard or the paper located on the gypsum is rubbed off as a result of the different rotational speeds, wherein, at the same time, the gypsum is broken, and thus comminuted further, on account of the distance between the rollers. Thereafter, the material processed by the second shredder is conveyed to a second screen. In the second screen, in particular the abraded paper or the paperboard as well as undesirable constituents, for example pieces of wood, pieces of stone or other contaminants, still located in the material are screened out.

The second screen preferably screens out pieces which are larger than 50 mm, preferably larger than 20 mm. The material which remains following the second screen, and is fed on for further recycling, thus particularly preferably has pieces measuring between 0 and 20 mm.

Following the second screen, the screened-out material is fed to a third shredder, which is designed in particular, once again, in the form of a roller crusher. This is equipped, in particular, with a pair of rollers comprising smooth rollers, wherein the distance between the smooth rollers, once again, is particularly preferably adjustable. As a result, the material, which now substantially comprises pieces of gypsum is broken into smaller pieces, wherein, particularly preferably on account of the rollers of the third shredder rotating at different rotational speeds from one another, the pieces of gypsum, at the same time, are also ground and the paper is thus rubbed off.

The third shredder is followed by a third screen, by means of which, once again, gypsum particles smaller than 3 mm, in particular smaller than 2 mm, preferably smaller than 1.8 mm, are screened out of the material. The screened-out gypsum particles are then fed particularly preferably to a collecting apparatus, which takes place in particular via a worm conveyor, although it is also possible to use some other conveyor, for example a belt conveyor.

The collecting apparatus is preferably a central collecting apparatus, and therefore the screened-out gypsum particles from the first screen and from the third screen are fed to the central collecting apparatus. The material which remains following the third screen thus just has negligible quantities of undesirable materials: gypsum particles larger than 1.8 mm, which, as they cannot be separated, can be fed on for further use. It is likewise possible for the material which remains following the third screening installation to be fed anew to the recycling plant as a whole.

It is preferable for the recycling plant to include a dust-extraction unit, in which case gypsum particles, which rise up in the air, or other kinds of dust, are filtered off in the different comminuting stations. It is also possible for these particles of dust to be fed on for further use and/or to be fed to the collecting apparatus for collecting the fine gypsum particles.

### BRIEF DESCRIPTION OF THE DRAWINGS

The present invention will now be described, by way of example, with reference to the accompanying drawings, in which:

FIG. 1 is a perspective view of the recycling plant; and

FIG. 2 is a plan view of the recycling plant shown in FIG. 1.

In the figures, the same reference designations are used for identical or similar components, even if a repeated description is omitted for reasons of simplicity.

### DETAILED DESCRIPTION OF SOME EMBODIMENTS

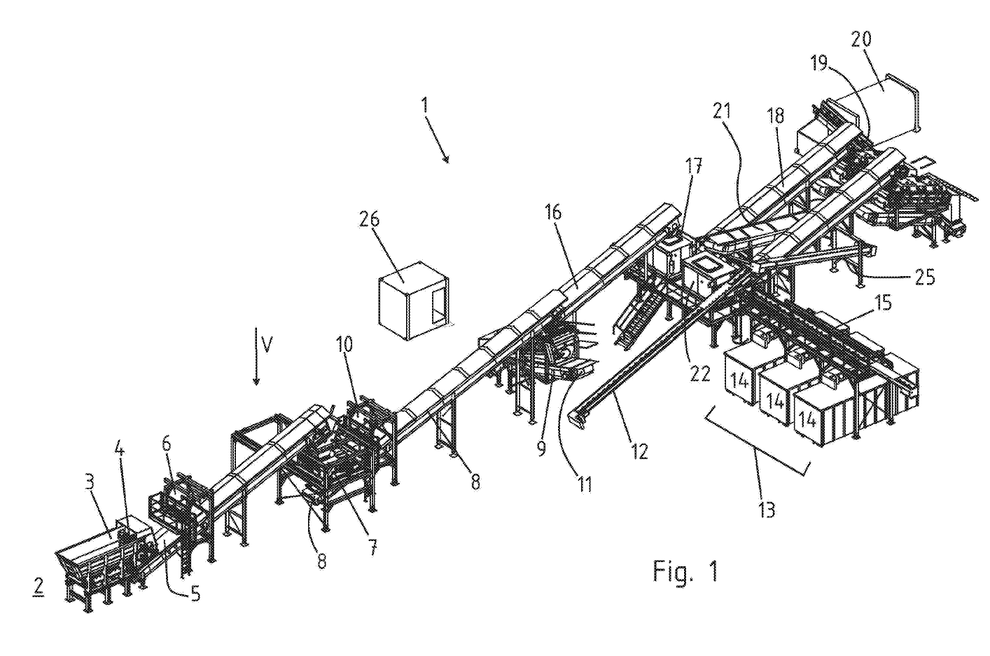

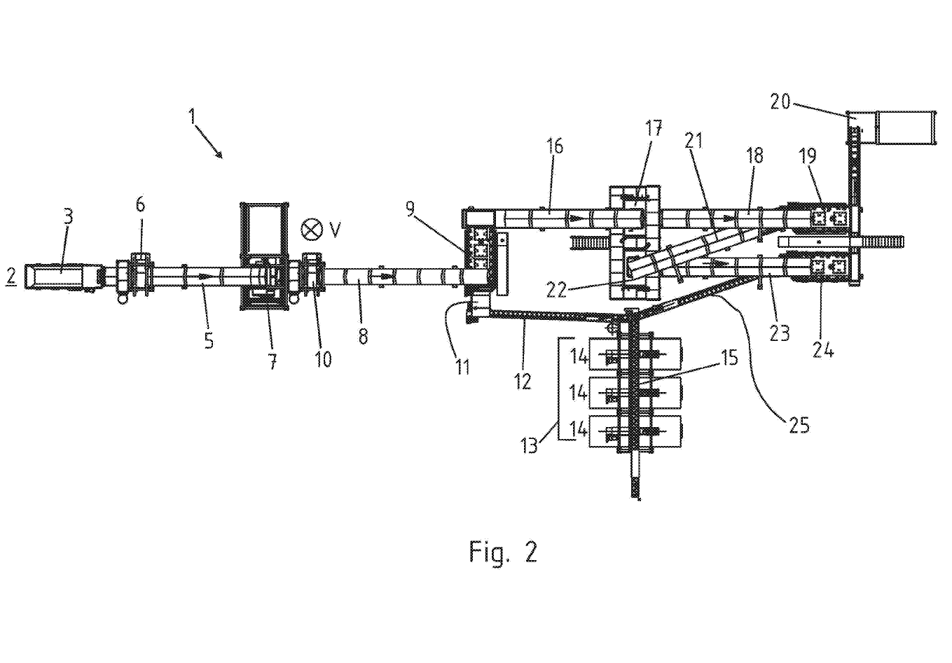

A recycling plant 1 is illustrated in FIGS. 1 and 2 having a receiving apparatus 3 at its beginning 2, in particular in the form of a bulk container. Roughly comminuted gypsum board (not shown) can then be introduced, in the form of bulk material, in the receiving apparatus 3. The receiving apparatus 3 may also have a coarse rasp 4, and therefore the gypsum boards can be slightly comminuted.

The material is then passed onto a first conveying belt 5 by the receiving apparatus 3, wherein a first magnetic separator 6 is arranged above the conveying belt. The magnetic force of the first magnetic separator 6 allows the separator to pick up metallic or constituents containing iron located in the material, wherein the non-magnetic parts of the material remain on the first conveying belt 5 by virtue of gravity. The material which remains on the first conveying belt 5 is then fed to a first shredder 7, which is configured in form of a screw mill. The material, which is fed to the screw mill via the first conveying belt 5 in a vertical direction V drops into the shredder 7 and passes through the latter on account of gravitational force and on account of the rollers rotating in relation to one another.

On an underside of the shredder 7, the material comminuted by the latter drops onto a second conveying belt 8, by which it is then transported onward in the transporting direction to a first screen 9. During transportation on the second conveying belt 8, the material comminuted by the first shredder 7 passes through a second magnetic separator 10, which likewise separates off once again magnetically conductive constituents from the comminuted material. The non-magnetic constituent parts of the comminuted material remain on the second conveying belt 8 on account of gravitational force.

The second conveying belt 8 then conveys the comminuted material to a first screen 9, which is designed preferably in the form of a flip-flow screen. The first screen 9 here screens out gypsum particles and conveys them by way of a conveying belt 11, which is assigned to the first screen 9, to a worm conveyor 12, wherein the gypsum particles already screened out in this stage of the recycling plant are then fed to a central collection apparatus 13 by the worm conveyor 12. The central collection apparatus 13 is formed here by three containers 14 where each container is filled by a central filling arrangement 15. Therefore, each container can be filled and, if a first container 14 is full, the other two containers 14 can be filled, while the first, full container 14 is changed over to an empty container 14. Therefore, the recycling process will not be interrupted.

The material which is not screened out by the first screen 9 is fed, via a third conveying belt 16, to a second shredder 17 in the form of a roller crusher. The passage through the second shredder 17 takes place once again by gravitational force and of the movement of the rollers of the second shredder 17 itself. The material which is comminuted by the second shredder 17 is then transported onward, via a fourth conveying belt 18, to a second screen 19, which is preferably configured in the form of a flip-flow screen. In the second screen 19, the material which is to be conveyed, in particular in pieces measuring between 0 and 20 mm, is screened out and fed on for further recycling. The oversized material screened out here consists of wood, styropor, paper or other undesirable materials. These are collected in a collecting container 20 and can then be put to other uses.

The material which is conveyed onward is then fed, via a fifth conveying belt 21, to a third shredder 22, which is likewise designed in the form of a roller crusher. The material which is to be conveyed is then conveyed from the third shredder 22, via a sixth conveying belt 23, to a third screen 24, which is likewise designed preferably in the form of a flip-flow screen. The third screen 24 then once again screens out gypsum particles, which are then fed, via a second worm conveyor 25, to the central collecting apparatus 13. The screened-out parts consisting of paper, wood or the like and also of gypsum residues which are larger than the predetermined gypsum particle size, can then also be fed on, in turn, for disposal or for further use.

The recycling plant makes it possible for the pieces of gypsum board for separation, containing different contaminants and/or of different sizes, to be recycled in effective and fail-safe manner and be separated from oversized particles and other undesirable materials. In particular the different shredders and the rollers thereof rotating at different speeds, make it quite possible to recycle even wet gypsum boards.

The foregoing description of some embodiments of the invention has been presented for purposes of illustration and description. It is not intended to be exhaustive or to limit the invention to the precise form disclosed, and modifications and variations are possible in light of the above teachings or may be acquired from practice of the invention. The specifically described embodiments explain the principles and practical applications to enable one ordinarily skilled in the art to utilize various embodiments and with various modifications as are suited to the particular use contemplated. It is intended that the scope of the invention be defined by the claims appended hereto, and their equivalents. Further, it should be understood that various changes, substitutions and alterations can be made hereto without departing from the spirit and scope of the invention as described by the appended claims.

1. A recycling plant for gypsum plasterboard, comprising:
a receiving apparatus for receiving comminuted gypsum boards in pieces measuring from 0 to 1000 mm,
a first magnetic separator for separating off large metallic contaminants,
a first shredder for comminuting the gypsum boards into pieces measuring from 10 to 100 mm,
a second magnetic separator for separating off metallic components,
a first screen for screening off gypsum particles smaller than 3 mm, in particular smaller than 2 mm,
a second shredder for comminuting the pieces of gypsum board from the first screening installation,
a second screen for screening off paper and undesirable materials,
a third shredder for comminuting the pieces of gypsum, and
a third screen for screening off the gypsum particles smaller than 3 mm, in particular smaller than 2 mm.

2. The recycling plant as claimed in claim 1, wherein the first shredder is a screw mill having three pairs of rollers.

3. The recycling plant as claimed in claim 2, wherein the two upper pairs of rollers operate at the same rotational speed, in particular at 20 to 40 rpm, and in that the third pair of rollers has a higher rotational speed than the latter.

4. The recycling plant as claimed in claim 1, wherein the upper pairs of rollers operate at a rotational speed of 20 to 40 rpm.

5. The recycling plant as claimed in claim 3, wherein the third pair of rollers operates at a rotational speed of 100 to 150 rpm.

6. The recycling plant as claimed in claim 3, wherein the third pair of rollers operates at a rotational speed of 120 to 140 rpm.

7. The recycling plant as claimed in claim 2, wherein the distance between the rollers of the lowermost pair of rollers of the screw mill can be adjusted in a variable manner via an actuator.

8. The recycling plant as claimed in claim 1, wherein the actuator can be activated automatically via a sensor arranged upstream of the lowermost pair of rollers, as seen in a conveying direction.

9. The recycling plant as claimed in claim 7, wherein the actuator is designed in the form of a hydraulic actuator.

10. The recycling plant as claimed in claim 1, wherein the first screen, the second screen and/or the third screen are designed in the form of flip-flow screens.

11. The recycling plant as claimed in claim 1, wherein the second shredder is a roller crusher, and wherein the two rollers operate at different speeds from one another and/or the two rollers have different profiles.

12. The recycling plant as claimed in claim 1, wherein one roller has a chevron profile and the other roller has an annular profile, and/or in that each roller has a dedicated drive motor.

13. The recycling plant as claimed in claim 1, wherein the third shredder is a roller crusher, and wherein the two rollers are designed in the form of smooth rollers.

14. The recycling plant as claimed in claim 1, wherein the two smooth rollers operate at different rotational speeds from one another.

15. The recycling plant as claimed in claim 1, wherein the screened-out gypsum particles from the first screen and from the third screen are conveyed to a central collecting apparatus, in particular via worm conveyors.

16. The recycling plant as claimed in claim 1, wherein the conveyor is a worm conveyor.
